(19) United States
(12) Patent Application Publication
(10) Pub. No.: US 2009/0300115 A1
(43) Pub. Date: Dec. 3, 2009

(54) METHOD, NODE AND SYSTEM FOR ADAPTING A SESSION INITIATION PROTOCOL (SIP) MESSAGE FOR AN IP MULTIMEDIA SUBSYSTEM (IMS)

(75) Inventor: Peter Postmus, Pierrefonds (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/132,357

(22) Filed: Jun. 3, 2008

(51) Int. Cl. G06F 15/16

(52) U.S. Cl. 709/205

(57) ABSTRACT

The invention relates to a method and a node at an entry point of an IP Multimedia Subsystem (IMS) for adapting a Session Initiation Protocol (SIP) message. The invention also relates to an IMS comprising the node and executing the method. The node comprises a port for receiving the SIP message from a client and a processor for executing a first function for detecting a client type, using information from the SIP message and for executing a second function for adapting the SIP message for the IMS, by adding an end point capability, such as feature tags and option tags, to the SIP message according to rules relative to the client type.

### FIELD OF THE INVENTION

The present invention relates to a method and system for adapting a session initiation protocol (SIP) message for an IP Multimedia Subsystem (IMS).

### BACKGROUND OF THE INVENTION

The IP Multimedia Subsystem (IMS) is a 3rd Generation Partnership Project (3GPP) standard created around the year 2000. Since then, several services, servers, devices, etc. have been deployed according to this standard and are now in use. These include, among others, network nodes and clients based on the IMS standards available at the time of the implementation.

However, the IMS standard has evolved over the years and new network nodes and clients have been developed and implemented according to more recent versions of the standard. For example, clients and nodes deployed according to more recent versions of the IMS standard, use feature tags which are added to requests made by clients. These feature tags usually indicate which clients should handle the requests or indicate the features supported by the clients. As a result, the network proxies can route the requests to and from the clients best capable of handling the requests and supporting feature tags as well.

Furthermore, recent IMS clients can publish their presence status in a presence document to a presence server. Part of this presence document also comprises tuples indicating the capability of the clients to communicate and to support specific services, such as chat, file transfer, games, etc. New IMS solutions, for example, rely increasingly on the existence on feature tags and service capabilities publication for their services to execute successfully.

Therefore, IMS clients designed according to older versions of the IMS standard can not interwork or communicate with clients or nodes designed according to newer versions of the IMS standard. Also, the IMS clients designed according to older versions of the IMS standard cannot use newer services developed according to newer versions of the IMS standard. Furthermore, solutions based on the Open Mobile Alliance (OMA) Instant Messaging (IM) standard v1 support feature tags but do not support the publishing of capabilities. Different devices, servers, clients, nodes or services thus cannot interwork properly due to these limitations.

### SUMMARY

Therefore it is an object of this invention to provide a method, a node and a system for adapting a session initiation protocol (SIP) message for an IP Multimedia Subsystem (IMS) and for addressing the afore-described problems and drawbacks.

According an aspect of the invention a method for adapting a Session Initiation Protocol (SIP) message for an IP Multimedia Subsystem (IMS) is provided. The method comprises the steps of receiving the SIP message from a client at an entry point of the IMS, detecting a client type, at the entry point, using information from the SIP message and adapting the SIP message for the IMS, at the entry point, by adding an end point capability to the SIP message according to rules relative to the client type.

According to another aspect of the invention, a node at an entry point of an IP Multimedia Subsystem (IMS), for adapting a Session Initiation Protocol (SIP) message is provided. The node comprises a port for receiving the SIP message from a client and a processor for executing a first function for detecting a client type, using information from the SIP message and for executing a second function for adapting the SIP message for the IMS, by adding an end point capability to the SIP message according to rules relative to the client type.

According to yet another aspect of the invention, a node at an entry point of an IP Multimedia Subsystem (IMS), for adapting a Session Initiation Protocol (SIP) message is provided. The node comprises a receiving means for receiving the SIP message from a client, a first processing means for detecting a client type, using information from the SIP message and a second processing means for adapting the SIP message for the IMS, by adding an end point capability to the SIP message according to rules relative to the client type.

According to still another aspect of the invention, an IP Multimedia Subsystem (IMS) is provided. The IMS comprises a destination node and a node for adapting a Session Initiation Protocol (SIP) message. The node comprises a port for receiving the SIP message from a client and a processor for executing a first function for detecting a client type, using information from the SIP message and for executing a second function for adapting the SIP message for the IMS, by adding an end point capability to the SIP message according to rules relative to the client type. The node also comprises a transmitter for transmitting the adapted SIP message from the node toward a destination node in the IMS.

### BRIEF DESCRIPTION OF THE DRAWINGS

The objects and advantages of the invention will be understood by reading the following detailed description in conjunction with the drawings.

FIG. 1 is an exemplary flowchart illustrating a method according to an embodiment of the invention.

FIG. 2 is an exemplary block diagram showing clients, an IP Multimedia Subsystem (IMS) and a node for adapting a Session Initiation Protocol (SIP) message for the IMS, according to an embodiment of the invention.

FIG. 3 is an exemplary block diagram showing clients, an IMS and a node for adapting the SIP message for the IMS, according to another embodiment of the invention.

FIG. 4 is an exemplary block diagram showing a client rules table in a memory.

### DETAILED DESCRIPTION

The various features of the invention will now be described with reference to the figures. These various aspects are described hereafter in greater detail in connection with exemplary embodiments and examples to facilitate an understanding of the invention, but should not be construed as limited to these embodiments. Rather, these embodiments are provided so that the disclosure will be thorough and complete, and will fully convey the scope of the invention to those skilled in the art.

Many aspects of the invention are described in terms of sequences of actions to be performed by elements of a computer system or other hardware capable of executing programmed instructions. It will be recognized that the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention.

The embodiments according to the present invention are described with reference to block diagrams and/or operational illustrations of methods, servers, and computer program products. It is to be understood that each block of the block diagrams and/or operational illustrations, and combinations of blocks in the block diagrams and/or operational illustrations, can be implemented by radio frequency, analog and/or digital hardware, and/or computer program instructions. These computer program instructions may be provided to a processor circuit of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Furthermore, in some illustrations, some blocks may be optional and may or may not be executed.

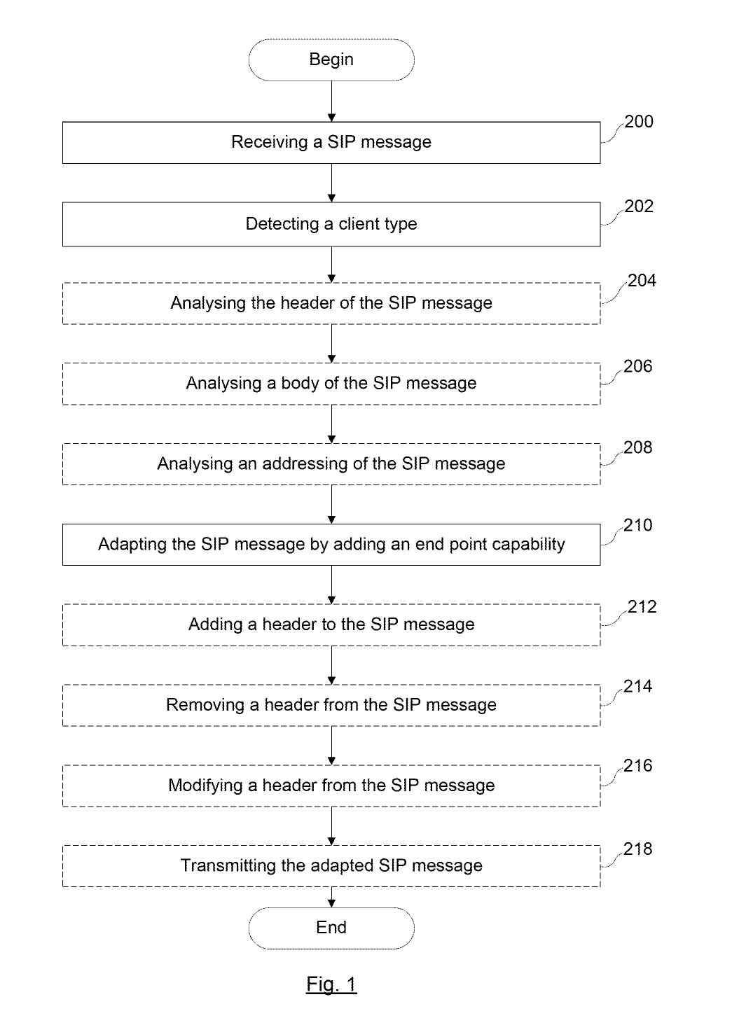

FIG. 1 illustrates a method for adapting a Session Initiation Protocol (SIP) message for an IP Multimedia Subsystem (IMS), according to the present invention. The method, comprises the steps of receiving 200 the SIP message from a client at an entry point of the IMS, detecting 202 a client type, at the entry point, using information from the SIP message and adapting 210 the SIP message for the IMS, at the entry point, by adding an end point capability to the SIP message according to rules relative to the client type.

The method may further comprise the step of transmitting 218 the adapted SIP message from the entry point toward a destination node in the IMS. Preferably, the entry point is a Proxy-Call Session Control Server (P-CSCF) and the client type may comprise a client version.

The step of detecting 202 may comprise, as shown by dotted boxes in the figures, detecting a port on which the SIP message was received by the entry point. Furthermore, the step of detecting 202 a client type may further comprise the step of analyzing 204 a header of the SIP message for detecting the client type, the step of analyzing 206 a body of the SIP message for detecting the client type or the step of analyzing 208 an addressing of the SIP message for detecting the client type. Furthermore, the step of adapting 210 the SIP message by adding an end point capability may further comprise the step of adding 212 a header to the SIP message. Still preferably, the method may further comprise the step of removing 214 or modifying 216 a header from the SIP message for adapting the SIP message for the IMS.

The end point capability may be an option tag or a feature tag or may be header features or SIP features, for example. The end point capability may also be features in the body of the message. The rules relative to how the end point capabilities are added based on the client type may be configurable.

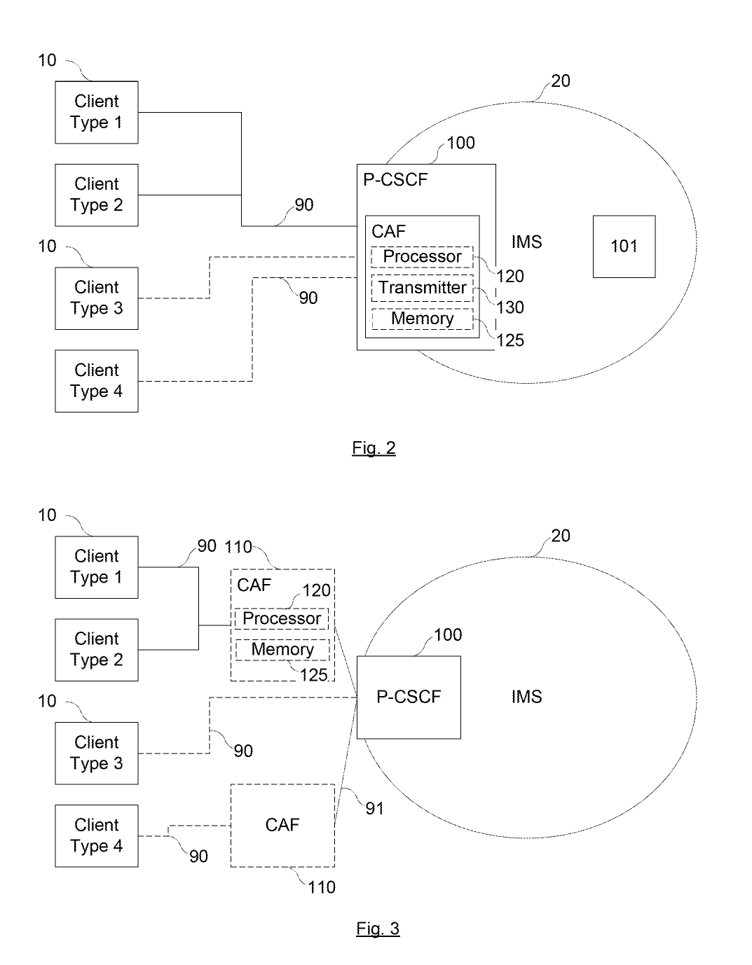

FIG. 2 illustrates a node 100 at an entry point of an IMS core network 20, for adapting a SIP message. The node 100 comprises a port 90 for receiving the SIP message from a client 10 and a processor 120, for executing a first function for detecting a client type, using information from the SIP message and for executing a second function for adapting the SIP message for the IMS, by adding an end point capability to the SIP message according to rules associating the client type and the end point capabilities.

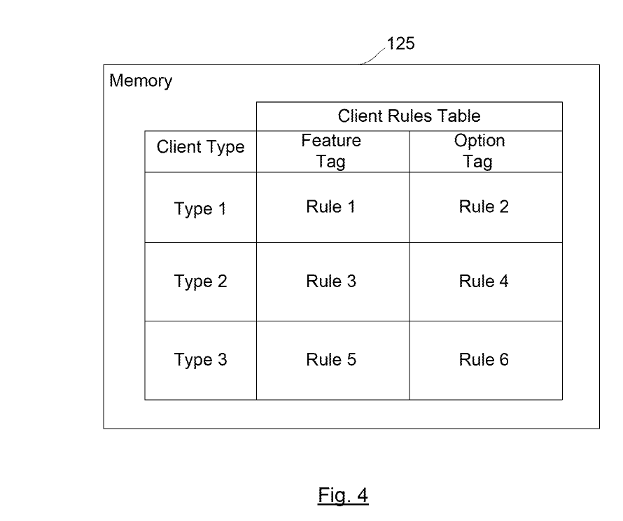

The node 100 may be a P-CSCF and may further comprise other ports for receiving SIP messages from other clients. The node 100 may also comprise a memory 125 for storing the rules relative to the client type. An exemplary table containing rules relative to client types is depicted in FIG. 4. Furthermore, the client type may comprise a client version and the end point capability may be an option tag or a feature tag.

FIG. 2 also illustrate an IMS core network 20. The IMS core network 20 comprises a destination node 101 and the node 100 for adapting a Session Initiation Protocol (SIP) message, as described before. The node 100 further comprises a transmitter 130 for transmitting the adapted SIP message from the node 100 toward the destination node 101 in the IMS.

This embodiment thus proposes to introduce a new function or set of functions in the network, and preferably in the P-CSCF, that can modify a request sent by a client 10 on behalf of the client so it is in line with the latest IMS standards and properly reflects the client capabilities.

Since all SIP requests and responses pass through the P-CSCF node this one can be advantageously modified as described to adapt requests and responses in order to allow the clients 10 corresponding to different implementations of the IMS protocol to interwork with the IMS core network 20.

Furthermore, multiple types of clients can be supported by one P-CSCF modified according to the present invention, by using different sockets, by using the user agent header or by using other characteristics of the requests or responses to identify the client type and to modify the requests and responses accordingly. In the exemplary embodiment of FIG. 2, the clients of type 1 and type 2 are on the same port 90 and the same logic could be applied. The client of type 3 is on another port 90 and other logic could be applied based on the port from a request is received. However, for the clients of type 1 and type 2 which are on the same port 90, a different logic, based on their client type detected from the request, could be applied.

FIG. 3 illustrates a node 110 at an entry point of an IMS, for adapting a SIP message. The node 110, also called Client Adaptation Function (CAF) comprises a receiving means 90 for receiving the SIP message from a client 10. This means can be a port, a socket or any equivalent means as it would be apparent to a person skilled in the art. The CAF also comprises a first processing means 120 for detecting a client type, using information from the SIP message or the socket on which the message was received. This means can be a software function or program as well as hardware specifically designed to execute this function, as it would be apparent to a person skilled in the art. The CAF further comprise a second processing means, which could be the same as the first processing means 120, for adapting the SIP message for the IMS, by adding, for example, an end point capability to the SIP message according to rules relative to the client type. This means can also be a software function or program as well as hardware specifically designed to execute this function, as it would be apparent to a person skilled in the art. Preferably, the CAF also comprises a memory 125 for storing the rules and a transmitting means 91 for transmitting the adapted SIP message towards the P-CSCF. Also, as explained above, the processing means could be implemented in many forms such as software or hardware.

This embodiment thus proposes to introduce a new node, the (CAF), in the network, which can modify a request or a response send by or to a client 10 on behalf of the client or on behalf of a node of the IMS so it is in line with the client and the latest IMS standards, for example, and reflects the client capabilities.

Still according to this embodiment of the invention, the client 10 may send a request to the IMS core network via an access network. Normally, the first access point in the IMS core network is the P-CSCF which receives the requests on a port 90, and then the P-CSCF routes the request to other nodes in the IMS network according to IMS routing rules.

The invention proposes the addition of a function, as shown in FIG. 2 or of a node 110, the CAF, which for the client 10 is the first access point to the IMS network. It may be totally transparent for the client which is not aware that it does not communicates directly with the P-CSCF, but rather with a node that has been added before the P-CSCF. A person skilled in the art would understand that the invention could be included in existing nodes in the network access as well as in a standalone function/node. It should be understood that the CAF can adapt requests sent from clients as well as responses sent to clients.

The CAF, upon reception of a request or of a response thus adapts the request or response by adding, removing or modifying SIP headers and/or content that the client itself has never been programmed to include as these contents were added in later versions of the IMS standard.

After modifying the request or response, the CAF sends it to the P-CSCF or to the client. This is transparent for the P-CSCF which is not aware that another network function or node modifies the request or response. The CAF is placed in the path of the requests and responses, and accordingly any request or response sent in a SIP dialog/session passes through the CAF.

Furthermore, more than one CAF function or node may be added to the network, as shown in FIG. 3. For example, one CAF could be available for each client type. Therefore, every client could be configured with the IP address and port number of the CAF supporting its type. According to such an embodiment, a CAF could support only a specific type of client, while in other embodiments, a CAF could support multiple types of clients.

Additionally, many implementation of logic could be applied to determine the client type from which a request comes from or to which a response should be addressed. Firstly, a user agent header, if included in the request or the response, could contain the client name and information about a specific version and type of client. Secondly, the port on which a request is received or on which a response is sent could also indicate a specific version and type of client. In this case, every client type could be configured to access a different port or socket on the CAF. Thus, depending on the port or the socket used, different logic rules could be applied to the requests or to the responses.

Furthermore, in another embodiment of the invention not all clients would have access to the IMS network via the CAF. If no adaptation of requests or responses is required the client could be configured to access directly the P-CSCF.

Additionally, not all requests or responses sent via the CAF need to be modified by the CAF. The CAF could be configured to handles specific request and responses only from certain types of clients. In such a case, requests and responses would pass through the CAF without being modified, as shown by client type 3 of FIG. 3.

As a person skilled in the art would readily understand, the CAF should be enabled with configurable, programmable or scriptable logic to identify the headers, header values or body modifications that would need to be made to a request or response. The CAF should be able to add, delete or modify content of headers, headers values of body of requests or responses. This logic would preferably be associated to client types. This logic could also be associated to specific sockets or ports, associated to specific types of clients, as described previously. This logic could further be associated with request or responses including specific user agent header, indicating a client type, for example.

In a first example, a client of e.g. “Type 1” can send/receive SIP MESSAGE requests which are always associated to an instant messaging service on the client. The client of this example does this in a similar way as Open Mobile Alliance (OMA) Instant Messaging (IM) but does not use the OMA IM feature tags. The operator would like to apply OMA IM logic in the network on the requests. For this it would need to have an OMA IM feature tag added to the request. If the operator would also want the OMA IM client and client “Type 1” to communicate with each other, the client “Type 1” would need to register with the OMA IM feature tag.

In order to do so, the client “Type 1” P-CSCF IP address and port may be configured with the socket of a corresponding CAF. The CAF would include logic to add the appropriate OMA IM feature tag to the REGISTER requests and to add the OMA IM feature tag to SIP MESSAGE requests, for example, or “require” or “explicit” tags, as shown in the next example.

In a second example, an incoming SIP request, CAF logic and the corresponding adapted SIP request are shown.

INCOMING SIP REQUEST:

MESSAGE tel:+5141234567 SIP/2.0
Via: SIP/2.0/UDP
[5555::aaa:bbb:ccc:ddd]:1357;branch=z9hG4bKnashds7
Max-Forwards: 70
Route: <sip:pcscf1.visited1.net:7531;lr>,
<sip:orig@scscf1.home1.net; lr>
P-Preferred-Identity: “John Doe” <tel:+15143457900>
P-Access-Network-Info: 3GPP-UTRAN-TDD; utran-cell-id-
3gpp=234151D0FCE11
From: <sip:user1_public1@home1.net>; tag=171828
To: < tel:+5141234567>
Call-ID: cb03a0s09a2sdfglkj490333
Cseq: 127 MESSAGE
Accept-Contact: *;+g.oma.sip-im;
Content-Type: text/plain
Content-Length: ...
Hello World!

Logic in CAF, for treating the previous request:

IF (SIP MESSAGE request received on port x) AND (no
explicit/require in ACCEPT-CONTACT header)
THEN add require/explicit tags

Outgoing SIP request:
MESSAGE tel:+5l4l234567 SIP/2.0
Via: SIP/2.0/UDP
[5555::aaa:bbb:ccc:ddd] :1357;branch=z9hG4bKnashds7
Max-Forwards: 70
Route: <sip:pcscf1.visited1.net:7531;lr>,
<sip:orig@scscf1.home1.net; lr>
P-Preferred-Identity: “John Doe” <tel:+l5l43457900>
P-Access-Network-Info: 3GPP-UTRAN-TDD; utran-cell-id-
3gpp=234151D0FCE11
From: <sip:user1_public1@home1.net>; tag=171828
To: < tel:+5141234567>
Call-ID: cb03a0s09a2sdfglkj490333
Cseq: 127 MESSAGE
Accept-Contact: *;+g.oma.sip-im;require/explicit
Content-Type: text/plain
Content-Length: ...
Hello World!

In the example above, the logic of the CAF has added a tag “require/explicit” to the “Accept-Contact:” field of the header of the SIP request.

The invention has been described with reference to particular embodiments. However, it will be readily apparent to those skilled in the art that it is possible to embody the invention in specific forms other than those of the embodiments described above. The described embodiments are merely illustrative and should not be considered restrictive in any way. The scope of the invention is given by the appended claims, rather than the preceding description, and all variations and equivalents that fall within the range of the claims are intended to be embraced therein.

What is claimed is:

1. A method for adapting a Session Initiation Protocol (SIP) message for an IP Multimedia Subsystem (IMS), comprising the steps of:
a) receiving the SIP message from a client at an entry point of the IMS;
b) detecting a client type, at the entry point, using information from the SIP message; and
c) adapting the SIP message for the IMS, at the entry point, by adding an end point capability to the SIP message according to rules associating the client type and the end point capabilities.

2. The method of claim 1, further comprising the step of transmitting the adapted SIP message from the entry point toward a destination node in the IMS.

3. The method of claim 1, wherein the entry point is a Proxy-Call Session Control Server (P-CSCF).

4. The method of claim 1, wherein the client type comprises a client version.

5. The method of claim 1, wherein the step of detecting comprises detecting a port on which the SIP message was received by the entry point.

6. The method of claim 1, wherein step b) further comprises the step of analyzing a header of the SIP message for detecting the client type.

7. The method of claim 1, wherein step b) further comprises the step of analyzing a body of the SIP message for detecting the client type.

8. The method of claim 1, wherein step b) further comprises the step of analyzing an addressing of the SIP message for detecting the client type.

9. The method of claim 1, wherein the end point capability is an option tag.

10. The method of claim 1, wherein the end point capability is a feature tag.

11. The method of claim 1, wherein adding an end point capability further comprises adding a header to the SIP message.

12. The method of claim 1, further comprising the step of removing a header from the SIP message for adapting the SIP message for the IMS.

13. The method of claim 1, further comprising the step of modifying a header from the SIP message for adapting the SIP message for the IMS.

14. The method of claim 1, wherein the rules relative to the client type are configurable.

15. A node at an entry point of an IP Multimedia Subsystem (IMS), for adapting a Session Initiation Protocol (SIP) message, the node comprising:
a port for receiving the SIP message from a client; and
a processor for executing:
a first function for detecting a client type, using information from the SIP message; and
a second function for adapting the SIP message for the IMS, by adding an end point capability to the SIP message according to rules relative to the client type.

16. The node of claim 15, wherein the node is a Proxy-Call Session Control Server (P-CSCF).

17. The node of claim 15, wherein the client type comprises a client version.

18. The node of claim 15, further comprising other ports for receiving SIP messages from other clients.

19. The node of claim 15, wherein the end point capability is an option tag.

20. The node of claim 15, wherein the end point capability is a feature tag.

21. The node of claim 15, further comprising a memory for storing the rules relative to the client type.

22. A node at an entry point of an IP Multimedia Subsystem (IMS), for adapting a Session Initiation Protocol (SIP) message, the node comprising:
receiving means for receiving the SIP message from a client;
first processing means for detecting a client type, using information from the SIP message; and
second processing means for adapting the SIP message for the IMS, by adding an end point capability to the SIP message according to rules relative to the client type.

23. An IP Multimedia Subsystem (IMS), comprising:
a destination node; and
a node for adapting a Session Initiation Protocol (SIP) message, the node comprising:
a port for receiving the SIP message from a client;
a processor for executing:
a first function for detecting a client type, using information from the SIP message; and
a second function for adapting the SIP message for the IMS, by adding an end point capability to the SIP message according to rules relative to the client type; and
a transmitter for transmitting the adapted SIP message from the node toward the destination node in the IMS.
